(19) United States
(12) Patent Application Publication
(10) Pub. No.: US 2025/0307503 A1
(43) Pub. Date: Oct. 2, 2025

(54) WELLBORE TEMPERATURE OPTIMIZATION AND PREDICATION METHOD INTEGRATING NUMERICAL MODELS AND MACHINE LEARNING

(71) Applicant: Southwest Petroleum University, Chengdu (CN)

(72) Inventors: Mou YANG, Chengdu (CN); Shuangmiao CHE, Chengdu (CN); Pengchao ZHAO, Chengdu (CN); Bin TANG, Chengdu (CN); Mulei ZHU, Chengdu (CN); Zeping SONG, Chengdu (CN); Xinquan ZHU, Chengdu (CN)

(21) Appl. No.: 19/232,177

(22) Filed: Jun. 9, 2025

(30) Foreign Application Priority Data
Aug. 28, 2024 (CN) 202411188166.0

(51) Int. Cl. G06F 30/27; G06F 111/06; G06F 111/10

(52) U.S. Cl. CPC G06F 30/27; E21B 47/07; E21B 2200/20; G06F 30/28; G06F 2111/06; G06F 2111/10; G06N 3/126

(57) ABSTRACT

A wellbore temperature optimization and predication method integrating numerical models and machine learning includes the following steps: establishing a wellbore-formation transient heat transfer model, obtaining an initial data set composed of relevant parameters, normalizing the initial data set, training a wellbore temperature prediction model by using a random forest algorithm, then optimizing the hyperparameters of the random forest algorithm by using a genetic algorithm, performing global optimization by using an annealing algorithm to obtain the optimized wellbore temperature and related parameters, calculating the wellbore temperature by substituting the optimized parameters into the wellbore-formation transient heat transfer model, and performing comparative verification on the optimized wellbore temperature and the calculated wellbore temperature.

### CROSS REFERENCE TO RELATED APPLICATIONS

The present disclosure claims the priority to the Chinese patent application with the filing No. 202411188166.0, entitled “WELLBORE TEMPERATURE OPTIMIZATION AND PREDICATION METHOD INTEGRATING NUMERICAL MODELS AND MACHINE LEARNING” and filed on Aug. 28, 2024 with the Chinese Patent Office, the contents of which are incorporated herein by reference in their entirety.

### TECHNICAL FIELD

The present application relates to the technical field of oil and gas development, and specifically to a wellbore temperature optimization and predication method integrating numerical models and machine learning.

### BACKGROUND ART

With the continuous deepening of oil and gas exploration and development field, the number of deep wells and ultra-deep wells has increased significantly, which also leads to a sharp rise in the temperature inside the wellbore, posing a severe test to the working stability of downhole precision instruments, fluid performance stability and well wall stability. In order to ensure the efficient and safe development of deep oil and gas resources, many oilfield companies have adopted cooling drilling fluid circulation cooling technology to effectively alleviate the high temperature problem during the circulation process in the wellbore.

Wellbore temperature is affected by many factors. The wellbore temperature calculation model with higher accuracy is a numerical solution method. This method establishes, based on the principle of energy conservation, a temperature calculation model for each control area of the wellbore-formation, and then applies the implicit finite difference method to solve it, to obtain the wellbore temperature distribution of the wellbore. Based on this method, the influence of various sensitive factors on the wellbore temperature may be analyzed, the sensitive factors including drilling fluid density, rheological parameters, specific heat capacity, thermal conductivity, pumping rate, drilling pressure, rotation speed, etc. At present, the single factor analysis method only obtains the degree of influence of each factor on the wellbore temperature, while the wellbore temperature is affected by multiple factors at the same time. When the values of individual parameters are optimal, the calculation result of the temperature model may be minimized. The application of these optimized parameters may eliminate the high temperature problem that undrilled wells or surrounding planned new wells face during the drilling process, and then the downhole temperature may be controlled to achieve the purpose of reducing the downhole temperature.

Meanwhile, machine learning algorithms may process large and complex data sets and automatically learn the inherent laws and patterns between data. The basic data set of drilled well data is used to train and optimize each data set, and then the optimal cooling construction parameters may be recommended. The recommended parameters, as references, are applied to the mathematical model to quickly obtain the lowest wellbore temperature of the undrilled well or the surrounding to-be-drilled new well, providing key methods and measures for the smooth implementation of wellbore cooling technical measures.

Therefore, it is necessary to develop a wellbore temperature optimization and prediction method integrating numerical models and machine learning to achieve accurate prediction and effectively optimized cooling of the wellbore temperature, thereby improving the safety and efficiency of mining operations.

### SUMMARY

In view of this, in order to overcome the fact that existing numerical models are mostly used to optimize a single parameter to guide cooling, the present application proposes a wellbore temperature optimization and prediction method integrating numerical models and machine learning, which trains a wellbore temperature prediction model by processing the actually-measured data of multiple wells on site, recommends multiple optimal parameters by using an optimization algorithm based on the prediction model, aiming to achieve reduction in the wellbore temperature, and then verifying the parameters optimized and recommended by machine learning by combining the established numerical model to ensure the accuracy and reliability of the optimized results, providing a new method for wellbore cooling.

In order to solve at least one of the above technical problems, the technical solution provided by the present application is as follows.

The technical solution adopted by the present application to solve the above problems is a wellbore temperature optimization and prediction method integrating machine learning and numerical models, including the following steps:
Step S1: establishing a wellbore-formation transient heat transfer model, based on the principle of energy conservation combined with the heat transfer mechanism of each control area of a wellbore-formation, in consideration of the influence of heat generated by fluid circulation frictional resistance and a complex heat source term on the wellbore temperature;
Step S2: obtaining an initial data set composed of relevant parameters by combining the actually-measured data of an on-site well group;
Step S3: normalizing the initial data set;
Step S4: training the wellbore temperature prediction model by using a random forest algorithm, and then optimizing hyperparameters of the random forest algorithm by using a genetic algorithm;
Step S5: globally optimizing the algorithm by using an annealing algorithm to obtain an optimized wellbore temperature;
Step S6: calculating the wellbore temperature by using the wellbore-formation transient heat transfer model combined with the optimized relevant parameters; and
Step S7: performing comparative verification on the wellbore temperature optimized in step S5 and the wellbore temperature calculated in step S6, where if the verification is passed, the optimized wellbore temperature is retained to guide control of the wellbore temperature, and if the verification is not passed, the pressure drop caused by the wellbore fluid circulation frictional resistance in the wellbore-formation transient heat transfer model is adjusted and the verification is re-performed until the verification is passed,
where in the wellbore-formation transient heat transfer model, the specific formula for the flow rate of drilling fluid is as follows:

$$Q = \frac{{wh}^{2}}{2 {K}^{\frac{1}{m}} {τ}_{w}^{2}} ( \frac{m}{1 + 2 m} ) {( {τ}_{w} - {τ}_{y} )}^{\frac{1 + m}{m}} ( {τ}_{w} + \frac{m}{1 + m} {τ}_{y} )$$

in the formula:

$$h = \frac{{D}_{2} - {D}_{1}}{2} ; w = \frac{π}{2} ( {D}_{2} + {D}_{1} )$$

D₂ represents the annulus outer diameter and D₁ represents the annulus inner diameter, mm; K represents the consistency coefficient; m represents the flow index; w represents the width of the fluid domain, m; and τ_{w} represents the wall shear stress, Pa, and [symbol] τ_{y} represents the yield stress, Pa;
the specific formula for heat generated by rotation speed and drilling pressure is as shown below:

$${S}_{d} = \frac{ξ fWR ( {D}^{2} + Dd + {d}^{2} )}{7 4.3 ( D + d )}$$

in the formula: S_{d} represents the heat generated by the drill bit breaking the rock, J; ξ=2.5939, represents the correction factor; f represents the friction coefficient between the drill bit and the formation; W represents the drilling pressure, N; R represents the rotation speed, rpm; D represents the outer diameter of the drill bit, m; and d represents the inner diameter of the drill bit, m;
the specific formula of the wellbore-formation temperature heat transfer model is as shown below:

$$ρ C ( \frac{\partial T}{\partial t} + {v}_{r} \frac{\partial T}{\partial r} + {v}_{z} \frac{\partial T}{\partial z} ) = \frac{k}{r} \frac{\partial T}{\partial r} + k \frac{{\partial }^{2} T}{\partial {r}^{2}} + k \frac{{\partial }^{2} T}{\partial {z}^{2}} + S$$

in the formula: T represents a temperature, ° C.; ρ represents a fluid density, kg/m³; C represents fluid specific heat capacity, J/(kg·° C.); k represents fluid thermal conductivity, W/(m·° C.); t represents time, s; S represents the complex heat source term; r and z represent a radial direction and an axial direction respectively; and v represents a flow velocity, m/s.

For the annular heat transfer model, the linear equation after discretization using the fully implicit finite difference method is expressed as follows:

$$2 π {r}_{po} {h}_{po} \cdot {T}_{p , j}^{n + 1} - [ \frac{{ρ}_{m} {qC}_{m}}{Δ {z}_{j}} + 2 π {r}_{po} {h}_{po} + 2 π {r}_{w} {h}_{w} + \frac{{ρ}_{m} {C}_{m} π ( {r}_{w}^{2} - {r}_{po}^{2} )}{Δ t} ] \cdot {T}_{a , j}^{n + 1} + \frac{{ρ}_{m} {qC}_{m}}{Δ {z}_{j}} \cdot {T}_{a , j + 1}^{n + 1} + 2 π {r}_{w} {h}_{w} \cdot {T}_{w , j}^{n + 1} = - {Q}_{Sa} - \frac{{ρ}_{m} {C}_{m} π ( {r}_{w}^{2} - {r}_{po}^{2} )}{Δ t} \cdot {T}_{a , j}^{n}$$

in the formula, rₚₒ represents the inner radius of a drill string, m; hₚₒ represents the convective heat transfer coefficient of the outer wall of the drill string, W/(m²·° C.); μₘ represents the density of the drilling fluid, kg/m³; q represents the flow rate, m³/s; Cₘ represents the specific heat capacity of the drilling fluid, J/(kg·° C.); h_{w} represents the convective heat transfer coefficient of the well wall, W/(m²·° C.); r_{w} represents the radius of the well wall, m; j represents the number of well depth nodes; n represents the number of time nodes; Tⁿ⁺¹ₚⱼ represents the wall temperature of the drill string at the well depth j and time n+1, ° C.; Tⁿ⁺¹ₐⱼ represents the annular temperature at the well depth j and time n+1, ° C.; Tⁿ⁺¹_{wj} represents the temperature of the well wall at the well depth j and time n+1, ° C.; Tⁿₐⱼ represents the annular temperature at the well depth j and time n, ° C.; Δzⱼ represents the depth step; Δt represents the time step; and Qₛₐ represents the heat generated by the complex heat source term, J.

The present application has the technical effects.

1. The present application establishes a wellbore temperature prediction model by training a large number of on-site data sets through a random forest algorithm, performs hyperparameter optimization on the model by using a genetic algorithm, where after optimization, the determination coefficient of the model reaches 0.978, proving that it has high prediction accuracy and good generalization ability. Moreover, the model can also achieve rapid prediction of the wellbore temperature, overcoming the shortcoming of complex, difficult and time-consuming calculation of traditional solving of the wellbore temperature field using numerical solutions, and thereby providing more timely and accurate temperature prediction for on-site operations.

2. Through the feature importance analysis in the random forest algorithm, the degree of influence of each parameter on the wellbore temperature can be effectively analyzed. Further, the global optimization is performed on key parameters within a reasonable parameter range by using the simulated annealing algorithm, to obtain the wellbore temperature after optimized cooling and corresponding recommended parameter combination. Then verification calculation is performed using the recommended parameters, by integrating the wellbore-formation transient heat transfer numerical model with high calculation accuracy, and the recommended parameters are used to guide the wellbore cooling operation if the result shows that the results of the simulated annealing optimization are highly accurate, which can effectively improve the wellbore cooling effect and realize multi-parameter optimization and intelligent control of the wellbore temperature.

### BRIEF DESCRIPTION OF DRAWINGS

In order to more clearly illustrate the technical solutions of the embodiments of the present application, the drawings required to be used in the embodiments will be briefly introduced below. It should be understood that the following drawings only show some embodiments of the present application and therefore should not be regarded as limiting the scope. For a person ordinarily skilled in this field, other related drawings may be obtained based on these drawings without paying creative work.

FIG. 1 is a technical flow chart of the present application;

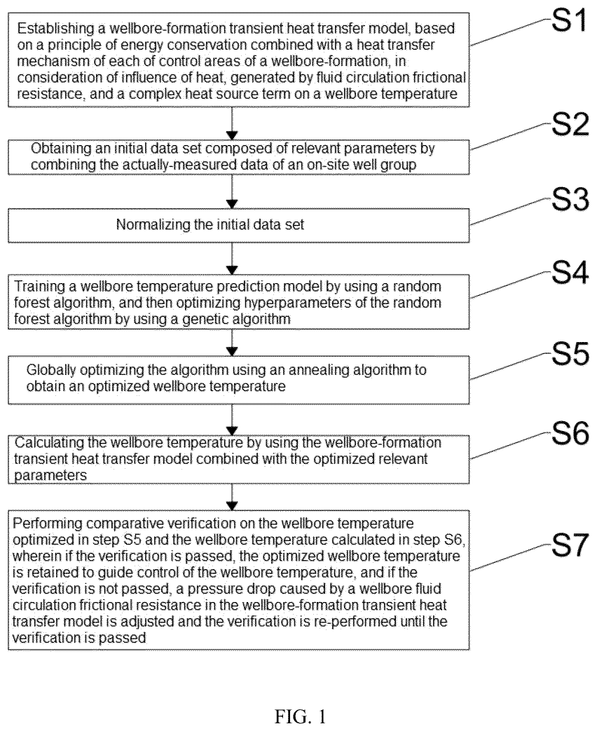

FIG. 2 is a distribution diagram of the model prediction value and the true value versus well depth in the present application;

FIG. 3 is a comparison diagram of the model prediction value and the true value in the present application;

FIG. 4 is a feature importance analysis diagram of the prediction model in the present application;

FIG. 5 is a comparison diagram of the wellbore temperature after simulated annealing optimization and the actually-measured temperature in the present application; and

FIG. 6 is a comparison diagram of the wellbore temperature after simulated annealing optimization and the wellbore temperature calculated by the numerical model using the optimized parameters in the present application.

### DETAILED DESCRIPTION OF EMBODIMENTS

The present application will be further described in detail below in conjunction with the embodiments and drawings.

In order to make the purposes, technical solutions and advantages of the embodiments of the present application clearer, the technical solutions in the embodiments of the present application will be clearly and completely described below in conjunction with the drawings in the embodiments of the present application. Obviously, the described embodiments are some, but not all of the embodiments of the present application. Based on the embodiments of the present application, all other embodiments obtained by a person ordinarily skilled in the art without creative work fall within the scope of protection of the present application. Therefore, the following detailed description of the embodiments of the present application provided in the drawings is not intended to limit the scope claimed in the present application, but merely represents selected embodiments of the present application.

### Example

A wellbore temperature optimization and prediction method integrating machine learning and numerical models includes the following steps:

Step S1: establishing a wellbore-formation transient heat transfer model, based on the principle of energy conservation combined with the heat transfer mechanism of each control area of a wellbore-formation, in consideration of the influence of heat generated by fluid circulation frictional resistance, and a complex heat source term on the wellbore temperature,
where the established wellbore-formation transient heat transfer model is solved discretely by using the fully implicit finite difference method, which mainly includes the following contents:
the difference between the incoming heat and outgoing heat of the heat transfer microelement plus the heat released by the internal heat source should be equal to the heat change of the microelement. The heat transfer control equation of each area is as shown in formula (1).

$$ρ C ( \frac{\partial T}{\partial t} + {v}_{r} \frac{\partial T}{\partial r} + {v}_{z} \frac{\partial T}{\partial z} ) = \frac{k}{r} \frac{\partial T}{\partial r} + k \frac{{\partial }^{2} T}{\partial {r}^{2}} + k \frac{{\partial }^{2} T}{\partial {z}^{2}} + S \qquad ( 1 )$$

In the formula (1), T represents a temperature, ° C.; p represents a fluid density, kg/m³; C represents fluid specific heat capacity, J/(kg·° C.); k represents fluid thermal conductivity, W/(m·° C.); t represents time, s; S represents the complex heat source term; r and z represent a radial direction and an axial direction respectively; and v represents a flow velocity, m/s.

In the process of the fluid in the drill string flowing downward, it is assumed that there is an axial velocity. Ignoring the velocity gradient of the fluid in the radial direction and the heat conduction of the drill string in the axial direction, the in-drill-string heat transfer model may be expressed as formula (2):

$${ρ}_{m} {C}_{m} ( \frac{\partial {T}_{pi}}{\partial t} + {V}_{zp} \frac{\partial {T}_{pi}}{\partial z} ) = \frac{{k}_{m}}{r} \frac{\partial {T}_{pi}}{\partial r} + {S}_{pf} \qquad ( 2 )$$

Convective heat transfer occurs between the fluid in the drill string and the wall of the drill string, and the boundary condition may be expressed as formula (3):

$$- {{k}_{m} ( \frac{\partial {T}_{pi}}{\partial r} )}_{r = {r}_{pi}} = {h}_{pi} ( {T}_{p} - {T}_{pi} ) \qquad ( 3 )$$

in the formulas (2) and (3), Tₚᵢ and Tₚ represent the temperatures of the fluid in the drill string and the wall of the drill string respectively, ° C.; μₘ represents the density of the drilling fluid, kg/m³; Cₘ represents the specific heat capacity of the drilling fluid, J/(kg·° C.); kₘ represents the thermal conductivity of the drilling fluid, W/(m·° C.); hₚᵢ represents the convection heat transfer coefficient of the inner wall of the drill string, W/(m²·° C.); rₚᵢ represents the inner radius of the drill string, m; v_{zp} represents the flow velocity of the fluid in the drill string, m/s; and S_{pf} represents the heat generated by the frictional resistance of the fluid circulation in the drill string, J.

The influence factor affecting the temperature of the wall of the drill string is the heat exchanged between the inner and outer wall surfaces thereof and the fluid through convective heat transfer. The heat transfer model of the wall of the drill string may be expressed as formula (4):

$${ρ}_{p} {C}_{p} \frac{\partial {T}_{p}}{\partial t} = \frac{{k}_{p}}{r} \frac{\partial {T}_{p}}{\partial r} \qquad ( 4 )$$

For the convective heat transfer generated between the fluid and the inner and outer walls of the drill string, the boundary conditions may be expressed by formulas (5) and (6):

$$- {{k}_{p} ( \frac{\partial {T}_{p}}{\partial r} )}_{r = {r}_{pi}} = {h}_{pi} ( {T}_{pi} - {T}_{p} ) \qquad ( 5 )$$

$$- {{k}_{ρ} ( \frac{\partial {T}_{p}}{\partial r} )}_{r = {r}_{po}} = {h}_{po} ( {T}_{a} - {T}_{p} ) \qquad ( 6 )$$

in the formulas (4) to (6), pp represents the density of drill string, kg/m³; Cₚ represents the specific heat capacity of the drill string, J/(kg·° C.); kₚ represents the thermal conductivity of the drill string, W/(m·° C.); rₚₒ represents the inner radius of the drill string, m; and hₚₒ represents the convective heat transfer coefficient of the outer wall of the drill string, W/(m²·° C.).

During the upward flowing of the annular fluid, convective heat transfer occurs between the annular fluid and the outer wall surface of the drill string and between the annular fluid and the wall surface of the well wall. Ignoring the velocity gradient of the fluid in the radial direction and the heat conduction of the drill string in the axial direction, the annular heat transfer model may be expressed as formula (7):

$${ρ}_{m} {C}_{m} ( \frac{\partial {T}_{a}}{\partial t} + {V}_{za} \frac{\partial {T}_{a}}{\partial z} ) = \frac{{k}_{m}}{r} \frac{\partial {T}_{a}}{\partial r} + {S}_{a} \qquad ( 7 )$$

When heat exchange occurs in the form of heat convection for the outer wall surface of the casing and the wall surface of the well wall, the boundary conditions of the two wall surfaces may be expressed by formulas (8) and (9):

$$- {{k}_{m} ( \frac{\partial {T}_{a}}{\partial r} )}_{r = {r}_{po}} = {h}_{po} ( {T}_{W} - {T}_{a} ) \qquad ( 8 )$$

$$- {{k}_{f} ( \frac{\partial {T}_{a}}{\partial r} )}_{r = {r}_{w}} = {h}_{w} ( {T}_{f} - {T}_{a} ) \qquad ( 9 )$$

In the formulas (7) to (9), Tₐ, T_{w} and T_{f} represent the temperatures of the annular fluid, the wall surface of the well wall and the formation, respectively, ° C.; v_{za} represents the flow velocity of the annular fluid, m/s; h_{w} represents the convective heat transfer coefficient of the well wall, W/(m²·° C.); k_{f} represents the thermal conductivity of the formation, W/(m·° C.); r_{w} represents the radius of the well wall, m; and Sₐ represents the heat generated by the complex heat source term, J.

The complex heat source term Sₐ mainly includes heat generated by the fluid circulation frictional resistance, and heat generated by drill string rotation, rock breaking by the drill bit, and nozzle pressure drop.

\textcircled{1} To calculate the heat generated by the annular fluid circulation frictional resistance, the τ_{w} equation for the flow rate Q of the given drilling fluid if firstly solved as shown in the formula (10):

$$Q = \frac{{wh}^{2}}{2 {K}^{\frac{1}{2}} {τ}_{W}^{2}} ( \frac{m}{1 + 2 m} ) {( {τ}_{w} - {τ}_{y} )}^{\frac{1 + m}{m}} ( {τ}_{w} + \frac{m}{1 + m} {τ}_{y} ) \qquad ( 10 )$$

In the above:

$$h = \frac{{D}_{2} - {D}_{1}}{2} ; w = \frac{π}{2} ( {D}_{2} + {D}_{1} ) .$$

Then, the generalized flow index Nis calculated according to the above formula. The calculation formula is as shown in formula (11):

$$\frac{3 N}{1 + 2 N} = \frac{3 m}{1 + 2 m} [ 1 - ( \frac{1}{1 + m} ) x - ( \frac{m}{1 + m} ) {x}^{2} ] \qquad ( 11 )$$

In the above:

$$x = \frac{{τ}_{y}}{{τ}_{w}} .$$

In the formulas (10)-(11), D₂ represents the annulus outer diameter, and D₁ represents the annulus inner diameter, mm; K represents the consistency coefficient; m represents the flow index; τ_{w} represents the shear stress of the wall surface, Pa; τ_{y} represents the yield stress, Pa; and w represents the flowing width of the fluid.

Then the annular fluid Reynolds number is calculated, and the fluid state (laminar flow, turbulent flow, transitional flow) is judged through the relationship between it with the critical Reynolds number. The calculation formula of the Reynolds number is as shown in formula (12):

$$R e = \frac{ρ {V}_{a} ( {D}_{2} - {D}_{1} )}{u} \qquad ( 12 )$$

In the formula (12), Vₐ represents the flow velocity of annular fluid, m/s; and u represents the fluid viscosity, Pa·s.

The calculation formula of the critical Reynolds number is as shown in the formula (13) and the formula (14):

$${Re}_{1} = 2 , 100 \cdot [ {N}^{0.331} ( 1 + 1.4 \; 02 κ - 0.9 \; 77 {κ}^{2} ) - 0.019 ε {N}_{κ}^{- 0.868} ] \qquad ( 13 )$$

$${Re}_{2} = 2 , 900 \cdot [ {N}^{- 0.039 {Re}_{1}^{0.307}} ] \qquad ( 14 )$$

In the formulas (13)-(14): N represents the generalized flow index, K represents the ratio of the annulus outer diameter to the annulus inner diameter, ε represents the eccentricity.

If Re<Re₁, the fluid state is the laminar flow; if Re<Re₂, the fluid state is the turbulent flow; and if Re₁<Re<Re₂, the fluid state is the transitional flow.

When the annular fluid is the laminar flow, the calculation formulas of frictional resistance coefficient when the annulus is non-eccentric and when it is eccentric are as shown in the formula (15) and the formula (16) respectively:

$${f}_{L} = \frac{24}{Re} \qquad ( 15 )$$

$${f}_{{L}_{2}} = {f}_{L} \cdot [ 1 - 0.072 \frac{ε}{N} {κ}^{0.8454} - 1.5 {ε}^{2} \sqrt{N} {κ}^{0.1852} + 0.96 {ε}^{3} \sqrt{N} {κ}^{0.2527} ] \qquad ( 16 )$$

When the annular fluid is the turbulent flow, the calculation formulas of frictional resistance coefficient when the annulus is non-eccentric and when it is eccentric are as shown in formula (17) and formula (18) respectively:

$${f}_{T}^{0.5} = \frac{4}{{N}^{0.75}} log ( Re {f}_{T}^{1 - N / 2} ) - \frac{0.39}{{N}^{1.2}} \qquad ( 17 )$$

$${f}_{{T}_{2}} = {f}_{T} \cdot [ 1 - 0.048 \frac{ε}{N} {κ}^{0.8454} - \frac{2}{3} {ε}^{2} \sqrt{N} {κ}^{0.1852} + 0.2 \; 58 {ε}^{3} \sqrt{N} {κ}^{0.2527} ] \qquad ( 18 )$$

When the annular fluid is the transitional flow, the calculation formulas of frictional resistance coefficient is as shown in formula (19):

$${f}_{tr} = {f}_{L} + \frac{( Re - {Re}_{1} ) ( {f}_{T} - {f}_{L} )}{{Re}_{2} - {Re}_{1}} \qquad ( 19 )$$

The pressure drop caused by circulation frictional resistance may be expressed as shown in formula (20):

$$\frac{dp}{dz} = 2 \frac{{ρ}_{m} {fv}_{2}}{{D}_{2} - {D}_{1}} \qquad ( 20 )$$

The heat generated by the circulation frictional resistance may be expressed as shown in formula (21):

$${S}_{f} = Q \cdot ( \frac{dp}{dz} ) \qquad ( 21 )$$

\textcircled{2} The heat generated by the friction of the drill bit breaking the rock at the bottom of the well may be expressed by equation (22):

$${S}_{d} = \frac{ξ fWR ( {D}^{2} + Dd + {d}^{2} )}{7 4.3 ( D + d )} \qquad ( 22 )$$

In the formula (22): S_{d} represents the heat generated by the drill bit breaking the rock, J; ξ=2.5939, represents the correction factor; f represents the frictional coefficient between the drill bit and the formation; w represents the drilling pressure, N; R represents the rotation speed, rpm; D represents the outer diameter of the drill bit, m; and d represents the inner diameter of the drill bit, m.

\textcircled{3} The nozzle pressure drop of the drill bit refers to the pressure drop value of the drilling fluid after the fluid passes through the nozzle of the drill bit. When the fluid flow rate and the size of the nozzle are constant, the expression of the drill bit pressure loss may be deduced based on the energy balance equation in hydrodynamics as shown in formula (23):

$$Δ {p}_{b} = \frac{5 \cdot {10}^{3} {ρ}_{m} {Q}^{2}}{{C}^{2} {A}_{0}^{2}} \qquad ( 23 )$$

In the formula (23): A₀² represents the equivalent diameter of the nozzle, m²; Q represents the flow rate of the drilling fluid, m³/s; and C represents the nozzle flow coefficient, which is usually taken as 0.95.

The heat generated by the nozzle pressure drop may be expressed through equation (24):

$${S}_{p} = Δ {p}_{b} \cdot Q \qquad ( 24 )$$

\textcircled{4} The rotation of the drill string causes the fluid to generate spiral flow and work, generating heat. The Reynolds number Re and Taylor number Ta are often used to describe the influence of the rotation on the pressure drop caused by frictional resistance. The pressure drop caused by rotation frictional resistance may be expressed by the following formula (25), and the heat generated by the rotation of the drill string is expressed by formula (26):

$${( \frac{{dp}_{a}}{dz} )}_{ω} = 0.36 {( 13.5 + \frac{{τ}_{y}}{ρ {v}^{2}} )}^{0.428} {ε}^{0.158} {n}^{0.054} {Ta}^{0.0319} {Re}^{0.042} {κ ( \frac{1}{κ} - 1 )}^{- 0.0152} \qquad ( 25 )$$

$${S}_{rl} = Q \cdot {( \frac{{dp}_{a}}{dz} )}_{ω} \qquad ( 26 )$$

in the above:

$$Ta = {{r}_{1} ( {r}_{2} - {r}_{1} )}^{3} {( \frac{{ρ}_{m} w}{μ} )}^{2} ; κ = \frac{{r}_{1}}{{r}_{2}} ;$$

In the formulas (25)-(26), τ_{y} represents the yield value of the Hershel-Bulkley fluid, Pa; ε represents the eccentricity; n represents the flow index; Re represents the Reynolds number; Ta represents the Taylor number; k represents the ratio of the wellbore radii; and u represents the fluid viscosity, Pa·s.

In summary, the complex heat source term Sₐ of the annular fluid may be expressed as formula (27):

$${S}_{a} = {S}_{p} + {S}_{d} + {S}_{f} + {S}_{rl} \qquad ( 27 )$$

Due to the area around the well wall is composed of rocks, cement ring, casing and static drilling fluid, the heat flowing thereof is mainly in the form of heat conduction. Therefore, the temperature model of the formation near the well wall may be expressed as formula (28):

$${ρ}_{f} {C}_{f} \frac{\partial {T}_{i}}{\partial t} = \frac{{k}_{f}}{{r}_{i}} \frac{\partial {T}_{i}}{\partial r} + {k}_{f} \frac{{\partial }^{2} {T}_{i}}{\partial {r}^{2}} \qquad ( 28 )$$

In the formula (28), Ti represents the temperature of each area near the well wall, ° C.; rᵢ represents the radial distance of each area, m; i represents the number of radial units, usually greater than 6; ρ_{f} represents the density of the rock near the well wall, kg/m³; and C_{f} represents the specific heat capacity of the rock near the well wall, J/(kg·° C.).

For the established mathematical model, the initial conditions for solving the model are given as follows:

\textcircled{1} Before drilling, the wellbore-formation has reached a thermodynamic equilibrium state. Therefore, the temperature of each control area (the fluid in the drill string, drill string wall, annular fluid and formation near the well wall, etc.) of the wellbore-formation is the temperature of the original formation. The mathematical model thereof may be expressed as:

$${T}_{k , j} = {T}_{s} + {g}_{f} z cos θ \qquad ( 29 )$$

In the formula (29): Tₖⱼ represents the temperature of the fluid in the drill string, drill string wall, annular fluid and formation near the well wall, ° C.; θ represents the well inclination angle, °; k represents the number of grid cells in the radial direction of the wellbore-formation, 1≤k≤11; j represents the number of grid cells in the axial direction; Tₛ represents the land surface temperature, ° C.; gf represents the geothermal gradient, ° C./100 m; and Z represents the well depth, m.

\textcircled{2} On the ground, the fluid temperature in the drill string is the inlet temperature of the fluid:

$${T}_{p} ( z = 0 , t ) = {T}_{in} \qquad ( 30 )$$

In the formula (30): Tᵢₙ represents the inlet temperature of the drilling fluid, ° C.

The boundary conditions for solving the model include:

\textcircled{1} The temperatures of the fluid in the drill string, the drill string wall and the annular fluid are all equal at the bottom depth of the well, that is:

$${T}_{ρ} ( z = H , t ) = {T}_{pi} ( z = H , t ) = {T}_{a} ( z = H , t ) \qquad ( 31 )$$

\textcircled{2} Far away from the well wall, the formation temperature is not disturbed, that is, the temperature far away from the well wall is the original temperature:

$$\frac{\partial {T}_{fk} ( r , z , t )}{\partial r} {\vert}_{r \to ∞} = 0 or {T}_{fk} ( r \to ∞ , z , t ) = {T}_{s} + {g}_{f} z cos θ \qquad ( 32 )$$

\textcircled{3} On the land surface, there is no heat exchange between each control area of the wellbore-formation and the atmosphere:

$$\frac{\partial {T}_{fk} ( r , z , t )}{\partial z} {\vert}_{z \to 0} = 0 or {T}_{fk} ( r , z = 0 ) = {T}_{s} \qquad ( 33 )$$

In order to accurately solve the transient temperature change of the wellbore, the finite difference method is used to discretize each heat transfer model of the wellbore-formation in time and space; then, the temperature data of the same time and space nodes at these discrete points are integrated to construct a linear equation system. According to equations (7)-(9), the annular heat transfer model may be discretely expressed as:

$${ρ}_{m} {qC}_{m} \frac{\partial {T}_{a}}{\partial z} + 2 π {r}_{po} {h}_{po} ( {T}_{p} - {T}_{a} ) - 2 π {r}_{w} {h}_{w} ( {T}_{a} - {T}_{w} ) + {Q}_{Sa} = {πρ}_{m} {C}_{m} ( {r}_{w}^{2} - {r}_{po}^{2} ) \frac{\partial {T}_{a}}{\partial t} \qquad ( 34 )$$

Then, the formula (34) is discretized in space and time, and may be expressed as:

$${ρ}_{m} q {C}_{m} \frac{{T}_{a , j + 1}^{n + 1} - {T}_{a , j}^{n + 1}}{Δ {z}_{j}} + 2 π {r}_{p o} {h}_{p o} ( {T}_{p , j}^{n + 1} - {T}_{a , j}^{n + 1} ) - 2 π {r}_{w} {h}_{w} ( {T}_{a , j}^{n + 1} - {T}_{w , j}^{n + 1} ) + {Q}_{S a} = π {ρ}_{m} {C}_{m} ( {r}_{w}^{2} - {r}_{po}^{2} ) \frac{{T}_{a , j}^{n + 1} - {T}_{a , j}^{n}}{Δ t} \qquad ( 35 )$$

By combining the same terms in the formula (35), the model may be expressed as the following linear equation:

$$( 36 )$$

$$2 π {r}_{p o} {h}_{p o} \cdot {T}_{ρ , j}^{n + 1} - [ \frac{{ρ}_{m} q {C}_{m}}{Δ {z}_{j}} + 2 π {r}_{p o} {h}_{p o} + 2 π {r}_{w} {h}_{w} + \frac{{ρ}_{m} {C}_{m} π ( {r}_{w}^{2} - {r}_{po}^{2} )}{Δ t} ] \cdot {T}_{a , j}^{n + 1} + \frac{{ρ}_{m} q {C}_{m}}{Δ {z}_{j}} \cdot {T}_{a , j + 1}^{n + 1} + 2 π {r}_{w} {h}_{w} \cdot {T}_{w , j}^{n + 1} = {Q}_{S a} - \frac{{ρ}_{m} {C}_{m} π ( {r}_{w}^{2} - {r}_{po}^{2} )}{Δ t} \cdot {T}_{a , j}^{n}$$

In the formulas (34) to (36), q represents the flow rate, m³/s; j represents the number of well depth nodes; n represents the number of time nodes; Tⁿ⁺¹ₚⱼ represents the temperature of the drill string wall at well depth j and time n+1, ° C.; Tⁿ⁺¹ₐⱼ represents the annular temperature at the well depth j and time n+1, ° C.; Tⁿ⁺¹_{wj} represents the temperature of the well wall at the well depth j and time n+1, ° C.; Tⁿₐⱼ represents the annular temperature at the well depth j and time n, ° C.; Δzⱼ represents the depth step; Δt represents the time step; and Qₛₐ represents the heat generated by the complex heat source term, J.

The above is the wellbore-formation transient heat transfer numerical module established based on the principle of energy conservation. By comprehensively considering the heat transfer mechanisms of different regions and the influence of the complex heat source term (including heat generated by fluid circulation frictional resistance, and heat generated by drill string rotation, rock breaking by the drill bit, and nozzle pressure drop) on the temperature, the corresponding transient heat transfer control equations are established for the inside of the drill string, the wall of the drill string, annulus and area near the well wall from inside to outside, the corresponding initial conditions and boundary conditions are given, and the finite difference method is used to discretely solve each equation. The established numerical models have high accuracy in predicting and calculating the wellbore temperature.

Step S2: obtaining the initial data set composed of relevant parameters by combining the actually-measured data of the on-site well group;

By sorting out the on-site actually-measured data of multiple wells, the well depth, drilling time, circulation time, inlet temperature, mechanical drilling speed, drilling pressure, rotation speed, flow rate and wellbore temperature are selected to form a data set for machine learning, where the bottom hole temperature is the prediction label and the others are feature labels. Some data sets are as shown in Table 1:

TABLE 1
Some datasets used for machine learning

| Well | Drilling | | Inlet | Mechanical | Drilling | Rotation | Flow | Bottom hole |
|---|---|---|---|---|---|---|---|---|
| depth | time | Circulation | temperature | drilling speed | pressure | speed | rate | temperature |
| (m) | (h) | time (h) | (° C.) | (m/h) | (KN) | (r/min) | (L/s) | (° C.) |
| 5782.00 | 1.82 | 2.90 | 22 | 7.69 | 13 | 80 | 30.5 | 133.2 |
| 5806.00 | 2.28 | 3.00 | 22 | 10.53 | 13 | 80 | 30.5 | 133.2 |
| 5820.00 | 1.29 | 2.19 | 22 | 10.85 | 13 | 80 | 30.5 | 131.7 |
| 5836.00 | 2.08 | 3.40 | 22 | 7.69 | 13.5 | 80 | 30.5 | 131.7 |
| 5855.00 | 2.02 | 2.86 | 22 | 9.41 | 13.5 | 80 | 30.5 | 127.3 |
| 5873.00 | 1.98 | 2.80 | 20 | 9.09 | 13.5 | 80 | 30.5 | 133.2 |
| 5892.00 | 1.96 | 2.83 | 20 | 9.69 | 13.5 | 80 | 30.5 | 134.0 |
| 5921.00 | 2.39 | 3.00 | 21 | 12.13 | 13.5 | 80 | 30.5 | 134.0 |
| 5938.00 | 1.60 | 2.72 | 22 | 10.63 | 13.5 | 80 | 30.5 | 134.0 |
| 5958.00 | 1.72 | 2.76 | 21 | 11.63 | 13.5 | 80 | 30.5 | 134.0 |
| 5980.00 | 1.70 | 2.91 | 22 | 12.94 | 13.5 | 80 | 30.5 | 136.2 |
| 6008.00 | 1.97 | 2.84 | 22 | 14.21 | 13.5 | 60 | 30.5 | 134.4 |
| 6020.00 | 2.39 | 2.83 | 19 | 5.02 | 13.5 | 60 | 30.5 | 134.7 |
| 6039.00 | 2.04 | 2.97 | 21 | 9.31 | 13.5 | 60 | 30.5 | 134.7 |
| 6060.00 | 2.32 | 2.86 | 22 | 9.05 | 13.5 | 60 | 29.5 | 136.2 |
| 6081.00 | 2.32 | 3.01 | 22 | 9.05 | 14.5 | 70 | 29.5 | 133.9 |
| 6098.00 | 1.69 | 2.79 | 21 | 10.06 | 14.5 | 65 | 29.5 | 131.7 |
| 6123.00 | 2.41 | 3.17 | 22 | 10.37 | 14.5 | 65 | 29.5 | 131.7 |
| 6143.00 | 1.92 | 2.61 | 22 | 10.42 | 14.5 | 65 | 29.5 | 133.9 |
| 6164.00 | 2.30 | 2.82 | 24 | 9.13 | 14.5 | 65 | 29.5 | 131.7 |
| 6185.00 | 2.24 | 2.85 | 25 | 9.38 | 15 | 65 | 29.5 | 131.0 |
| 6209.00 | 2.50 | 2.97 | 25 | 9.60 | 15 | 65 | 29.5 | 131.0 |
| 6236.00 | 2.66 | 2.86 | 25 | 10.15 | 15 | 65 | 29.5 | 131.0 |
| 6257.00 | 2.22 | 2.89 | 25 | 9.46 | 15 | 65 | 29.5 | 131.7 |
| 6276.00 | 1.96 | 2.75 | 25 | 9.69 | 15 | 65 | 29.5 | 131.7 |
| 6291.00 | 2.38 | 2.98 | 25 | 6.30 | 15 | 65 | 29.5 | 131.7 |
| 6305.00 | 2.87 | 2.90 | 24 | 4.88 | 15 | 65 | 29.5 | 133.2 |
| 6307.00 | 1.98 | 3.08 | 24 | 1.01 | 15 | 65 | 29.5 | 133.2 |

Step S3: normalizing the initial data set;

Since there are dimensional inconsistency among the parameters in the data set, data normalization is applied to proportionally transform the original data into the [0,1] interval to ensure that the data have uniform magnitude.

Some normalized data is as shown in Table 2:

TABLE 2
Part of the data set after normalization

| Well | Drilling | Circulation | Inlet | Mechanical | Drilling | Rotation | |
|---|---|---|---|---|---|---|---|
| depth | time | time | temperature | drilling | pressure | speed | Flow rate |
| (m) | (h) | (h) | (° C.) | speed (m/h) | (KN) | (r/min) | (L/s) |
| 0.716 | 0.547 | 0.099 | 0.125 | 0.229 | 0.500 | 0.800 | 0.444 |
| 0.726 | 0.746 | 0.113 | 0.125 | 0.326 | 0.500 | 0.800 | 0.444 |
| 0.732 | 0.319 | 0.000 | 0.125 | 0.337 | 0.500 | 0.800 | 0.444 |
| 0.739 | 0.659 | 0.168 | 0.125 | 0.229 | 0.625 | 0.800 | 0.444 |
| 0.747 | 0.634 | 0.093 | 0.125 | 0.287 | 0.625 | 0.800 | 0.444 |
| 0.754 | 0.616 | 0.085 | 0.063 | 0.277 | 0.625 | 0.800 | 0.444 |
| 0.762 | 0.608 | 0.089 | 0.063 | 0.297 | 0.625 | 0.800 | 0.444 |
| 0.775 | 0.793 | 0.113 | 0.094 | 0.381 | 0.625 | 0.800 | 0.444 |
| 0.782 | 0.453 | 0.074 | 0.125 | 0.329 | 0.625 | 0.800 | 0.444 |
| 0.790 | 0.504 | 0.079 | 0.094 | 0.364 | 0.625 | 0.800 | 0.444 |
| 0.800 | 0.496 | 0.100 | 0.125 | 0.408 | 0.625 | 0.800 | 0.444 |
| 0.812 | 0.612 | 0.090 | 0.125 | 0.452 | 0.625 | 0.000 | 0.444 |
| 0.817 | 0.793 | 0.089 | 0.031 | 0.137 | 0.625 | 0.000 | 0.444 |
| 0.825 | 0.642 | 0.108 | 0.094 | 0.284 | 0.625 | 0.000 | 0.444 |
| 0.834 | 0.763 | 0.093 | 0.125 | 0.275 | 0.625 | 0.000 | 0.222 |
| 0.842 | 0.763 | 0.114 | 0.125 | 0.275 | 0.875 | 0.400 | 0.222 |
| 0.850 | 0.491 | 0.083 | 0.094 | 0.310 | 0.875 | 0.200 | 0.222 |
| 0.860 | 0.802 | 0.136 | 0.125 | 0.321 | 0.875 | 0.200 | 0.222 |
| 0.869 | 0.591 | 0.058 | 0.125 | 0.322 | 0.875 | 0.200 | 0.222 |
| 0.878 | 0.754 | 0.088 | 0.188 | 0.278 | 0.875 | 0.200 | 0.222 |
| 0.886 | 0.728 | 0.092 | 0.219 | 0.286 | 1.000 | 0.200 | 0.222 |
| 0.897 | 0.841 | 0.108 | 0.219 | 0.294 | 1.000 | 0.200 | 0.222 |
| 0.908 | 0.909 | 0.093 | 0.219 | 0.313 | 1.000 | 0.200 | 0.222 |
| 0.917 | 0.720 | 0.097 | 0.219 | 0.289 | 1.000 | 0.200 | 0.222 |
| 0.925 | 0.608 | 0.078 | 0.219 | 0.297 | 1.000 | 0.200 | 0.222 |
| 0.931 | 0.789 | 0.110 | 0.219 | 0.181 | 1.000 | 0.200 | 0.222 |
| 0.937 | 1.000 | 0.099 | 0.188 | 0.132 | 1.000 | 0.200 | 0.222 |
| 0.938 | 0.616 | 0.124 | 0.188 | 0.000 | 1.000 | 0.200 | 0.222 |

Step S4: training the wellbore temperature prediction model by using the random forest algorithm, and then optimizing hyperparameters of the random forest algorithm by using the genetic algorithm.

The random forest algorithm is an integrated learning method that improves the performance and stability of the model mainly by constructing multiple decision trees. The principle of random forest algorithm is as follows.

First, the Bagging method is used to perform random sampling, that is, the training data set is randomly sampled with replacement:

Bagging: a data set containing N samples is random sampled with replacement to generate K subsample sets, each of which also contains N samples. For the k-th subsample set, the definition is as shown in formula (37):

$$( 37 )$$

$${D}_{k} = \{ ( {x}_{i} , {y}_{i} ) \vert i ∈ random sampling with replacement from \{ 1 , 2 , … , N \} \}$$

Secondly, a decision tree is constructed for each subsample, and at the node of each decision tree, a part of features are randomly selected to determine the best splitting, thereby increasing the diversity of the model and reducing the risk of overfitting:
node splitting: at the node of each decision tree, m features (m<M, where M is the total number of features) are randomly selected, the splitting point of each feature is calculated, and the feature and its splitting point that can maximally reduce the Gini index for splitting are selected. The Gini index is defined as shown in formula (38):

$$Gini ( D ) = 1 - {\sum }_{k = 1}^{K} {p}_{k}^{2} \qquad ( 38 )$$

In the formula (38): pₖ represents the proportion of class-k samples in the data set, and K represents the total number of classes.

Finally, the prediction results of all decision trees are integrated and the average value is taken as the prediction result of the random forest algorithm, as shown in formula (39):

$$\hat{y} = \frac{1}{B} {\sum }_{b = 1}^{B} {\hat{y}}_{b} \qquad ( 39 )$$

In the formula (39): ŷ represents the final prediction result, ŷ_{b} represents the prediction result of the b-th decision tree, and B represents the total number of decision trees.

For the preprocessed data set, the training samples and test samples are divided in a ratio of 8:2.

Meanwhile, in order to further improve the accuracy of the random forest prediction model, the random forest hyperparameters n_estimators (number of decision trees), max_depth (maximum depth of the tree), min_samples_leaf (minimum number of samples) and min_samples_split (minimum number of split samples) are optimized by using the genetic algorithm (GA) combined with the five-fold cross-validation method. The genetic algorithm population size is set to 40, the mutation probability is 0.05, and the maximum number of iterations is 50. Different hyperparameter combinations are iteratively generated and evaluated to find the optimal parameter combination. After optimization, the optimal hyperparameter combination is as shown in Table 3 below:

TABLE 3
GA optimization result

| Hyperparameter | Set Value |
|---|---|
| n_estimators | 150 |
| max_depth | 5 |
| min_samples_leaf | 2 |
| min_samples_split | 4 |

After optimization by the genetic algorithm, the random forest prediction model is evaluated using the determination coefficient (R²). The calculation formula of the determination coefficient is as shown in formula (40):

$${R}^{2} = 1 - \frac{{\sum }_{i = 1}^{n} {( {y}_{i} - {x}_{i} )}^{2}}{{\sum }_{i = 1}^{n} {( {y}_{i} - y )}^{2}} \qquad ( 40 )$$

In the formula (40): n represents the number of test sets, xᵢ represents the prediction value, yᵢ represents the true value, and y represents the average value of the true values.

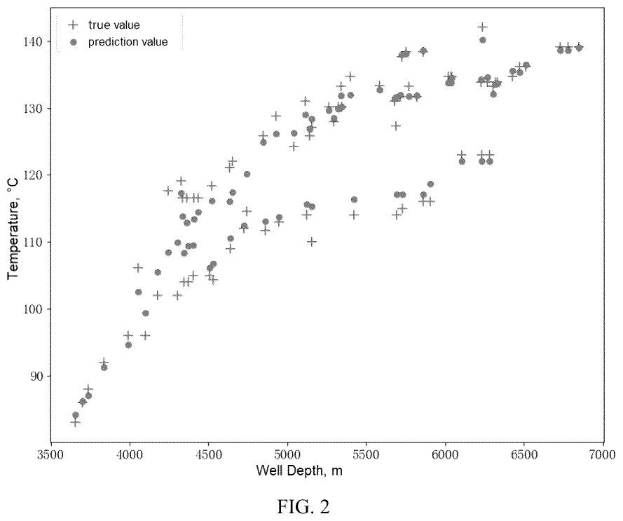

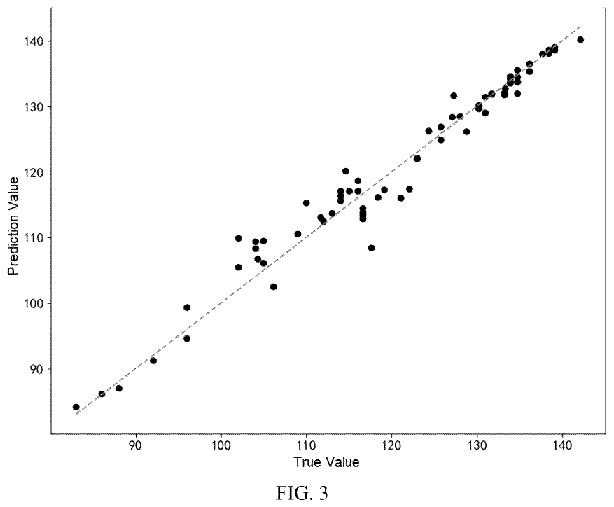

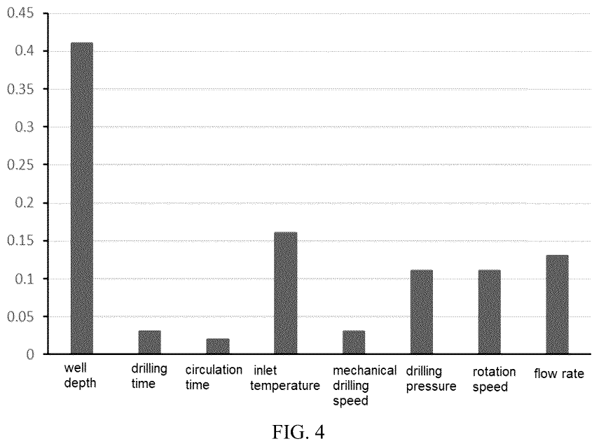

The determination coefficient R² is used to measure the correlation between the true value and the prediction value, and the value thereof is between 0 and 1. The closer the value is to 1, the better the prediction performance of the model is. The determination coefficient of the optimized wellbore temperature prediction model is about 0.978, which proves that this model has a very high prediction accuracy. The comparison between the model prediction value and the true value of the wellbore temperature is as shown in FIG. 2 and FIG. 3. Based on this prediction model, the feature importance analysis of each feature parameter on the bottom hole temperature is performed, which can reflect the contribution of each feature to the prediction performance of the entire model. The result of the feature importance analysis is as shown in FIG. 4. The feature importance of the feature Xⱼ to the model is calculated as shown in formula (41):

$$FI ( {X}_{j} ) = \frac{1}{B} {\sum }_{t = 1}^{B} Δ l ( t , {X}_{j} ) \qquad ( 41 )$$

In the formula (41): B represents the total number of decision trees, and Δl(t, Xⱼ) represents the impurity reduction caused by the feature Xⱼ at the t-th tree.

Step S5: globally optimizing the algorithm by using an annealing algorithm to obtain an optimized wellbore temperature.

After determining the feature parameters to be optimized, the simulated annealing algorithm is used for global optimization, to find the optimal parameters to minimize the wellbore temperature. The simulated annealing algorithm, which is a general probabilistic algorithm based on the principle of solid annealing, is mainly used to find the optimal solution of a proposition in a large search space.

Its core formula is mainly based on the Metropolis criterion: that is, certain inferior solutions are allowed to be accepted, instead of being blindly rejected. That is, even if a local optimal solution is found, the iteration continues until the global optimal solution is found. Assuming that the energy state of the solid here is E_{old}, by slightly disturbing the internal structure of the solid to obtain a new state, whose energy is E_{new}, the probability of accepting the state after the disturbance is as shown in formula (42):

$$P = \{ \begin{matrix}1 & E ( {x}_{n e w} ) < E ( {x}_{o l d} ) \\ exp ( - \frac{E ( {x}_{n e w} ) - E ( {x}_{o l d} )}{T} ) & E ( {x}_{n e w} ) \geq E ( {x}_{o l d} )\end{matrix} \qquad ( 42 )$$

In the formula (42): T represents the current temperature.

The attenuation function of the temperature is controlled to be as shown in formula (43):

$${T}_{k + 1} = α {T}_{k} , k = 0 , 1 , 2 … \qquad ( 43 )$$

In the formula (43), a represents a constant close to 1, usually taken as 0.5˜0.99.

The basic process of simulated annealing is divided into the following four steps: \textcircled{1} giving an initial temperature T₀ (i.e., the current optimal solution), and randomly generating an initial solution x₀ (i.e., x_{old}) at the same time, and calculating E(x₀) of the current objective function; \textcircled{2} executing the third step if the current temperature reaches that meeting the internal circulation stop condition, otherwise, giving a disturbance to the current solution to generate a new solution x₁ (x_{new}), and calculating ΔE=E(X₁)−E(x₀), where if ΔE<0, the new solution is accepted, and if ΔE≥0, the new solution is accepted with the probability

$$exp ( - \frac{E ( {x}_{n e w} ) - E ( {x}_{old} )}{T} )$$

by using the Metropolis criterion, and the new solution is used as the current solution when the new solution is accepted, otherwise, the second step is repeated; \textcircled{3} k=k+1, executing the temperature attenuation function, and executing the fourth step if the termination condition is met, otherwise, executing the second step; and \textcircled{4} ending the operation, where T reaches the termination temperature, i.e. the global optimal solution is found.

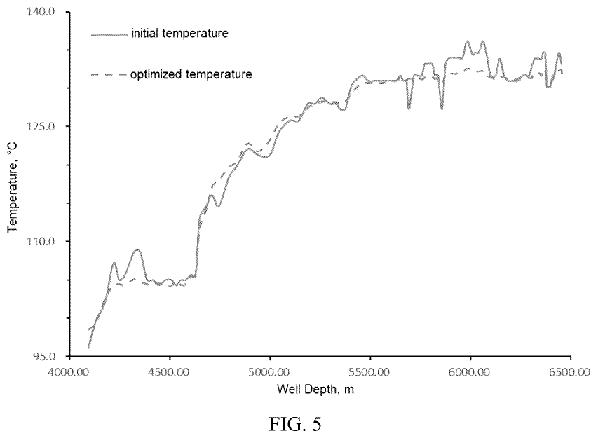

First, the original parameter values of the data set are used as the initial values of the optimization parameters, and the values are stored in a NumPy array initial_parameters. Next, the search space (i.e., parameter range) of five optimization parameters is given. Here, the range of each parameter in the data set is used for assignment and stored in the parameter_bounds list. Then the dual_annealing method in the simulated annealing algorithm is called, and the above initial values and search space are assigned to this function to minimize the objective function (wellbore temperature), and finally the optimal parameter value is returned. Finally, the optimal parameters are applied to a copy of the original data row (the original parameters are replaced with the optimal parameters), the new data row is converted to DataFrame format, and the loaded normalization class is used for normalization, and finally, the loaded prediction model is used to predict the optimized new data row, to finally obtain the optimized wellbore temperature. The optimized parameter combination and the optimized temperatures are saved as Excel files for further data analysis. The comparison between the actually-measured temperatures and the optimized wellbore temperatures are as shown in FIG. 5. It can be seen from the figure that in the well depth range of 4,000 m to 5,800 m, the difference between the optimized temperature and the initial temperature is small, and the optimization range is small. After the well depth reaches 5,800 m, the optimized temperature is 3-4° C. lower than the initial temperature, indicating that the optimization algorithm has played a certain role in temperature control. The recommended parameters of some well sections after optimization are as shown in Table 4:

TABLE 4
Optimized parameters and results of some well sections

| | Optimized | Optimized | Optimized | | Optimized |
|---|---|---|---|---|---|
| Well | inlet | drilling | rotation | Optimized | bottom hole |
| depth | temperature | pressure | speed | flow rate | temperature |
| (m) | (° C.) | (KN) | (r/min) | (L/s) | (° C.) |
| 5517.00 | 49.222 | 11.546 | 86.046 | 30.348 | 130.700 |
| 5544.00 | 48.517 | 12.462 | 87.936 | 30.371 | 130.633 |
| 5574.00 | 21.725 | 12.349 | 87.348 | 28.973 | 130.725 |
| 5605.00 | 17.212 | 12.484 | 86.062 | 30.429 | 130.990 |
| 5631.00 | 25.938 | 12.121 | 87.017 | 29.315 | 131.039 |
| 5647.00 | 25.838 | 11.987 | 87.971 | 29.415 | 131.291 |
| 5662.00 | 25.041 | 12.411 | 86.172 | 28.861 | 131.041 |
| 5678.00 | 24.616 | 13.914 | 60.647 | 30.642 | 131.050 |
| 5690.00 | 25.727 | 11.784 | 87.351 | 28.621 | 131.228 |
| 5716.00 | 25.816 | 11.742 | 86.164 | 29.313 | 131.317 |
| 5734.00 | 25.452 | 14.383 | 61.065 | 30.748 | 131.365 |
| 5755.00 | 26.307 | 14.402 | 60.200 | 28.488 | 131.156 |
| 5782.00 | 25.786 | 12.208 | 60.284 | 28.907 | 131.372 |
| 5806.00 | 26.279 | 14.866 | 60.829 | 28.654 | 131.555 |
| 5820.00 | 25.667 | 14.384 | 61.836 | 29.518 | 131.479 |
| 5836.00 | 26.295 | 14.766 | 67.358 | 28.627 | 131.204 |
| 5855.00 | 25.942 | 14.268 | 62.004 | 30.175 | 131.305 |
| 5873.00 | 25.914 | 14.351 | 64.014 | 28.350 | 130.665 |
| 5892.00 | 26.130 | 11.993 | 62.172 | 28.364 | 131.687 |
| 5921.00 | 26.301 | 12.431 | 60.784 | 28.337 | 131.977 |
| 5938.00 | 25.045 | 12.370 | 61.315 | 28.841 | 131.856 |
| 5958.00 | 26.945 | 12.142 | 62.453 | 28.011 | 132.067 |
| 5980.00 | 26.965 | 11.628 | 60.219 | 28.304 | 132.101 |
| 6008.00 | 25.723 | 11.735 | 62.354 | 29.946 | 132.565 |
| 6020.00 | 25.885 | 12.350 | 61.239 | 29.976 | 132.424 |
| 6039.00 | 25.743 | 11.730 | 94.711 | 28.132 | 132.229 |
| 6060.00 | 25.711 | 11.913 | 61.931 | 28.775 | 132.183 |
| 6081.00 | 26.296 | 11.924 | 60.816 | 28.068 | 132.264 |

Step S6: calculating the wellbore temperature using the wellbore-formation transient heat transfer model combined with the optimized related parameters;

Step S7: performing comparative verification on the wellbore temperature optimized in step S5 and the wellbore temperature calculated in step S6, where if the verification is passed, the optimized wellbore temperature is retained to guide control of the wellbore temperature, and if the verification is not passed, the pressure drop caused by the wellbore fluid circulation frictional resistance in the wellbore-formation transient heat transfer model is adjusted and the verification is re-performed until the verification is passed.

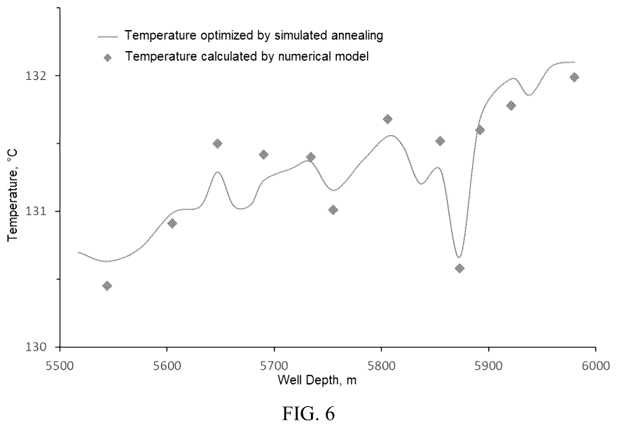

By combining the numerical model established in step S1 with the recommended parameters after optimization using the simulated annealing algorithm as shown in Table 4 above, the numerical model is used to calculate the wellbore temperature for this well section. Some calculation results are as shown in Table 5 below. The comparison between the temperature after simulated annealing optimization and the wellbore temperature solved using the numerical model is as shown in FIG. 6. It can be seen from the figure that at the same well depth, the error between the two is small, and the mean square error between the temperature curve calculated by the model and the temperature curve predicted by machine learning is less than or equal to 2%. It is believed that the model has a calculation result with high accuracy and can be applied to on-site cooling calculation and analysis, further verifying that the parameters recommended after multi-parameter optimization using machine learning can be used to guide wellbore cooling.

TABLE 5
Calculation results of numerical model using recommended parameters

| Well depth(m) | 5544 | 5605 | 5647 | 5690 | 5734 | 5755 |
|---|---|---|---|---|---|---|
| Calculation | 130.36 | 130.86 | 131.5 | 131.42 | 131.4 | 131.01 |
| temperature (° C.) | | | | | | |
| Well depth(m) | 5806 | 5855 | 5873 | 5892 | 5921 | 5980 |
| Calculation | 131.68 | 131.52 | 130.58 | 131.6 | 131.78 | 131.99 |
| temperature (° C.) | | | | | | |

In the description of the present application, it should be pointed out that the orientations or positional relationships indicated by terms such as “upper”, “lower”, “front”, “back”, “left”, “right”, “top”, “bottom”, “inside”, and “outside” are based on the orientations or positional relationships shown in the drawings, only for facilitating describing the present application and simplifying the description, rather than indicating or implying that the device or element referred to must have a specific direction, be constructed and operated in a specific direction, and should not be understood as a limitation on the present application.

The above are only preferred specific embodiments of the present application, but the protection scope of the present application is not limited thereto. Any changes or substitutions that can be easily thought of by a person skilled in the art within the technical scope disclosed in the embodiments of the present application should be included in the protection scope of the present application. Therefore, the protection scope of the present application should be based on the protection scope of Claims.

1. A wellbore temperature optimization and predication method integrating numerical models and machine learning, comprising following steps:
Step S1: establishing a wellbore-formation transient heat transfer model, based on a principle of energy conservation combined with a heat transfer mechanism of each of control areas of a wellbore-formation, in consideration of influence of heat, generated by fluid circulation frictional resistance, and a complex heat source term on a wellbore temperature;
Step S2: obtaining an initial data set composed of relevant parameters by combining actually-measured data of an on-site well group;
Step S3: normalizing the initial data set;
Step S4: training a wellbore temperature prediction model by using a random forest algorithm, and then optimizing hyperparameters of the random forest algorithm by using a genetic algorithm;
Step S5: globally optimizing the algorithm using an annealing algorithm to obtain an optimized wellbore temperature;
Step S6: calculating the wellbore temperature by using the wellbore-formation transient heat transfer model combined with the optimized relevant parameters;
Step S7: performing comparative verification on the wellbore temperature optimized in step S5 and the wellbore temperature calculated in step S6, wherein if the verification is passed, the optimized wellbore temperature is retained to guide control of the wellbore temperature, and if the verification is not passed, a pressure drop caused by a wellbore fluid circulation frictional resistance in the wellbore-formation transient heat transfer model is adjusted and the verification is re-performed until the verification is passed,
wherein in the wellbore-formation transient heat transfer model, a formula for a flow rate of a drilling fluid is as follows:
$$O = \frac{{wh}^{2}}{2 {K}^{\frac{1}{m}} {τ}_{w}^{2}} ( \frac{m}{1 + 2 m} ) {( {τ}_{w} - {τ}_{y} )}^{\frac{1 + m}{m}} ( {τ}_{w} + \frac{m}{1 + m} {τ}_{y} )$$
in the formula:
$$h = \frac{{D}_{2} - {D}_{1}}{2} ; w = \frac{π}{2} ( {D}_{2} + {D}_{1} )$$
D₂ represents an annulus outer diameter and D₁ represents an annulus inner diameter, mm; K represents a consistency coefficient; m represents a flow index; w represents a width of a fluid domain, m; and τ_{w} represents a wall shear stress, Pa, and τ_{y} represents a yield stress, Pa;
a formula for heat generated by rotation speed and drilling pressure is as shown below:
$${S}_{d} = \frac{ξ fWR ( {D}^{2} + Dd + {d}^{2} )}{7 4.3 ( D + d )}$$
in the formula: S_{d} represents heat generated by a drill bit breaking a rock, J; ξ=2.5939, represents a correction factor; f represents a friction coefficient between the drill bit and the formation; w represents the drilling pressure, N; R represents the rotation speed, rpm; D represents an outer diameter of the drill bit, m; and d represents an inner diameter of the drill bit, m;
a formula of a wellbore-formation temperature heat transfer model is as shown below:
$$ρ C ( \frac{\partial T}{\partial t} + {v}_{r} \frac{\partial T}{\partial r} + {v}_{z} \frac{\partial T}{\partial z} ) = \frac{k}{r} \frac{\partial T}{\partial r} + k \frac{{\partial }^{2} T}{\partial {r}^{2}} k \frac{{\partial }^{2} T}{\partial {z}^{2}} + S$$
in the formula: T represents a temperature, ° C.; ρ represents a fluid density, kg/m³; C represents fluid specific heat capacity, J/(kg·° C.); k represents fluid thermal conductivity, W/(m·° C.); t represents time, s; S represents the complex heat source term; r and z represent a radial direction and an axial direction respectively; and v represents a flow velocity, m/s;
for an annular heat transfer model, a linear equation after discretization using a fully implicit finite difference method is expressed as follows:
$$2 π {r}_{p o} {h}_{p o} \cdot {T}_{ρ , j}^{n + 1} - [ \frac{{ρ}_{m} q {C}_{m}}{Δ {z}_{j}} + 2 π {r}_{p o} {h}_{p o} + 2 π {r}_{w} {h}_{w} + \frac{{ρ}_{m} {C}_{m} π ( {r}_{w}^{2} - {r}_{po}^{2} )}{Δ t} ] \cdot {T}_{a , j}^{n + 1} + \frac{{ρ}_{m} q {C}_{m}}{Δ {z}_{j}} \cdot {T}_{a , j + 1}^{n + 1} + 2 π {r}_{w} {h}_{w} \cdot {T}_{w , j}^{n + 1} = {Q}_{S a} - \frac{{ρ}_{m} {C}_{m} π ( {r}_{w}^{2} - {r}_{po}^{2} )}{Δ t} \cdot {T}_{a , j}^{n}$$
in the formula, rₚₒ represents an inner radius of a drill string, m; hₚₒ represents a convective heat transfer coefficient of an outer wall of the drill string, W/(m²·° C.); μₘ represents a density of the drilling fluid, kg/m³; q represents a flow rate, m³/s; Cₘ represents specific heat capacity of the drilling fluid, J/(kg·° C.); h_{w} represents a convective heat transfer coefficient of a well wall, W/(m²·° C.); r_{w} represents a radius of the well wall, m; j represents number of well depth nodes; n represents number of time nodes; Tⁿ⁺¹ₚⱼ represents a temperature of a wall of the drill string at a well depth j and time n+1, ° C.; Tⁿ⁺¹ₐⱼ represents an annular temperature at the well depth j and the time n+1, ° C.; Tⁿ⁺¹_{wj} represents a temperature of the well wall at the well depth j and the time n+1, ° C.; Tⁿₐⱼ represents an annular temperature at the well depth j and time n, ° C.; Δzⱼ represents a depth step; Δt represents a time step; and Qₛₐ represents heat generated by the complex heat source term, J.

2. The wellbore temperature optimization and predication method integrating numerical models and machine learning according to claim 1, wherein the relevant parameters constituting the initial data set comprise: well depth, drilling time, circulation time, inlet temperature, mechanical drilling speed, drilling pressure, rotation speed, flow rate, and wellbore temperature.

3. The wellbore temperature optimization and predication method integrating numerical models and machine learning according to claim 2, wherein the wellbore temperature is a prediction label of the random forest algorithm, and the remaining parameters are feature labels.

4. The wellbore temperature optimization and predication method integrating numerical models and machine learning according to claim 1, wherein the comparative verification in step S7 comprises considering, if a mean square error between the temperature calculated by the model and the temperature predicted by machine learning is less than or equal to 2%, that the model has a calculation result with high accuracy and can be applied to on-site cooling calculation and analysis.
